(19) United States
(12) Patent Application Publication
(10) Pub. No.: US 2009/0248867 A1
(43) Pub. Date: Oct. 1, 2009

(54) NETWORK SYSTEM, DEVICE, CONTROL METHOD THEREOF, AND STORAGE MEDIUM

(75) Inventor: Norihisa Kishimoto, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/415,270

(22) Filed: Mar. 31, 2009

(30) Foreign Application Priority Data
Apr. 1, 2008 (JP) 2008-095231

(51) Int. Cl. G06F 15/173

(52) U.S. Cl. 709/224; 709/223; 715/700

(57) ABSTRACT

A network system capable of autonomously changing a management configuration of a management device and managed devices in the network system. One of a plurality of devices connected to a network operates as a parent device that collects data from the other devices, and the remaining devices operate as child devices that transmit data to the parent device. When the load of the parent device becomes high, at least one of the child devices is selected and upgraded to a parent device. When the load of the original parent device decreases, the device upgraded to the parent device is automatically returned to the child device.

### BACKGROUND OF THE INVENTION

1. Field of the Invention

The present invention relates to a network system, a device of the network system, a control method of the device, and a storage medium storing a program for realizing the control method.

2. Description of the Related Art

Recent devices represented by image forming apparatuses are connected to a network and able to exchange various data therebetween. For example, such image forming apparatus is adapted to not only transmit job data but also transmit data including management information on the image forming apparatus, log information, etc. to a personal computer or a management server. The log information includes information for immediate error analysis, information representing an operation state of the apparatus, etc.

In some cases, one of the devices on the network has high hardware or software specs and is adapted to collect, e.g., management data on at least one other device.

In the above management configuration on the network, there can occur an increase in the load of the management device (hereinafter referred to as the parent device) that manages other devices. At that time, in a system proposed in, for example, Japanese Laid-open Patent Publication No. 2003-186765, a device different from the parent device is selected and assigned with the authority to manage managed devices (hereinafter ref erred to as the child devices). The device assigned with the authority is upgraded to the parent device, and the device releasing the authority is downgraded to a child device, whereby a process for interchanging the managing side and the managed side is autonomously performed.

Japanese Laid-open Patent Publication No. 2003-67279 discloses a system in which when the load on a parent device becomes high, one of child devices is selected and upgraded to a parent device, thereby performing processing to increase the number of parent devices and reduce the load on the parent device.

With the above described prior art techniques, the management configuration on the network can be autonomously changed and the number of parent devices can be autonomously increased, but there is no way to automatically restore the management configuration thus changed.

As a result, in a case, for example, that the management configuration set by an administrator or a user of the parent device is temporarily changed upon temporary increase in the load on the parent device, a problem is raised that even if the load on the parent device is restored to its ordinary level, the original management configuration cannot automatically be restored, and therefore, the devices continue to operate under the management configuration different from the original management configuration set by the administrator or the user. To restore the original management configuration, the settings of management configuration must be restored by the administrator of devices or the network administrator.

### SUMMARY OF THE INVENTION

The present invention provides a network system able to change a management configuration of a management device and managed devices on a network with a change in a state of the management device and able to automatically restore the original management configuration upon restoration of the original state of the management device, and provides a device, a control method of the device, and a storage medium storing a program for realizing the control method.

According to a first aspect of this invention, there is provided a network system including a plurality of devices connected to a network, at least one of the plurality of devices being configured to operate as a management device that collects and manages data transmitted from at least one remaining device that operates as at least one managed device, the network system comprising a changing unit adapted to change at least one of the at least one managed device to a new management device in a case where there occurs a change in state of the management device, and a unit adapted to change the new management device to a managed device in a case where the state of the management device is restored to its original state.

According to a second aspect of this invention, there is provided a device connected to a plurality of other devices via a network, comprising a collecting unit adapted to collect data transmitted from the plurality of other devices, a detecting unit adapted to detect a state of the device, a changing unit adapted to change at least one of the plurality of other devices from a managed device to a management device in a case where the detecting unit detects that load on the device is high, and a unit adapted to change the device changed to the management device by the changing unit to the managed device in a case where the detecting unit detects that the load of the device is low.

According to a third aspect of this invention, there is provided a device adapted to operate as a managed device managed by a management device, comprising a changing unit adapted to change the device such as to operate as a new management device in response to an instruction transmitted from the management device to change the device to the new management device, a receiving unit adapted to receive, from the management device, information indicating at least one device to be managed by the device changed to the new management device by the management device, a collecting unit adapted to collect data from the at least one device to be managed by the new management device in accordance with the information received by the receiving unit, and a unit adapted to change the device such as to operate as a managed device in response to an instruction transmitted from the management device to change the device to the managed device.

According to a fourth aspect of this invention, there is provided a network system including a plurality of devices connected to a network on which a server apparatus is disposed, at least one of the plurality of devices being configured to operate as a management device that collects data transmitted from at least one remaining device that operates as at least one managed device and the collected data being managed by the server apparatus, the network system comprising a changing unit adapted to change at least one of the at least one managed device to a new management device in accordance with an instruction transmitted from the server apparatus in a case where there occurs a change in state of the management device, and a unit adapted to change the device changed to the new management device by the changing unit to a managed device in accordance with an instruction transmitted from the server apparatus in a case where the state of the management device is restored to its original state.

According to a fifth aspect of this invention, there is provided a device connected to a server apparatus and a plurality of other devices via a network, comprising a collecting unit adapted to collect data transmitted from the plurality of other devices, a detecting unit adapted to detect a state of the device, a changing unit adapted to change at least one of the plurality of other devices from a managed device to a management device in accordance with information transmitted from the server apparatus in a case where the detecting unit detects that load on the device is high, and a unit adapted to change the device changed to the management device by the changing unit to the managed device in accordance with information transmitted from the server apparatus in a case where the detecting unit detects that the load of the device is low.

According to a sixth aspect of this invention, there is provided a control method of a device connected to a plurality of other devices via a network, comprising a collecting step of collecting data transmitted from the plurality of other devices, a detecting step of detecting a state of the device, a changing step of changing at least one of the plurality of other devices from a managed device to a management device in a case where it is detected in the detecting step that load on the device is high, and a step of changing the device changed to the management device in the changing step to the managed device in a case where it is determined in the detecting step that the load of the device is low.

According to a seventh aspect of this invention, there is provided a control method of a device adapted to operate as a managed device managed by a management device, comprising a changing step of changing the device such as to operate as a new management device in response to an instruction transmitted from the management device to change the device to the new management device, a receiving step of receiving, from the management device, information indicating at least one device to be managed by the device changed to the new management device in the changing step, a collecting step of collecting data from the at least one device to be managed by the new management device in accordance with the information received in the receiving step, and a step of changing the device such as to operate as a managed device in response to an instruction transmitted from the management device to change the device to the managed device.

According to eighth and ninth aspects of this invention, there are provided computer-readable storage media storing programs for causing a computer to execute the control methods of device according to the second and third aspects of this invention.

With this invention, it is possible to autonomously change a management configuration of a network F on which there are a management device and managed devices. When the state of the management device changes, the management configuration of the management device and the managed devices can be changed. In addition, when the state of the management device is restored to the original state, the original management configuration can be automatically restored. Accordingly, the burden on the user or the administrator of devices or the network administrator to restore the original management configuration can be reduced.

Further features of the present invention will become apparent from the following description of exemplary embodiments with reference to the attached drawings.

### BRIEF DESCRIPTION OF THE DRAWINGS

FIG. 1 is a schematic view showing the construction of a network system including devices according to a first embodiment of this invention;

FIG. 2 is a block diagram showing the hardware construction of an image forming apparatus in FIG. 1;

FIG. 3 is a sequence diagram showing communications performed when a parent device collects data;

FIG. 4 is a block diagram showing the software construction of a device that only operates as a child device;

FIG. 5 is a block diagram showing the software construction of a device able to operate as a parent device;

FIG. 6 is a view showing an example screen displayed on an operation panel of the parent device;

FIG. 7 is a view showing another example screen displayed on the operation panel of the parent device;

FIG. 8 is a schematic view showing management ranges after execution of load distribution according to the first embodiment;

FIGS. 9A and 9B are table diagrams showing lists held by the parent device;

FIGS. 10A and 10B are table diagrams showing lists held by the parent device after the load distribution;

FIGS. 11A and 11B are table diagrams showing lists held by a new parent device after the load distribution;

FIGS. 12A and 12B are table diagrams showing lists held by the parent device at execution of load redistribution;

FIGS. 13A and 13B are table diagrams showing example lists held by the parent device in a case that the original configuration is restored after the load redistribution;

FIG. 14 is a sequence diagram showing communications performed when a child device is upgraded to a parent device and communications performed when the parent device is downgraded to the child device;

FIG. 15 is a part of a flowchart showing the internal process implemented by the parent device;

FIG. 16 is the remaining part of the flowchart which follows the part shown in FIG. 15;

FIG. 17 is a schematic view showing the construction of a network system including devices according to a second embodiment of this invention;

FIG. 18 is a block diagram showing the hardware construction of a management server;

FIG. 19 is a sequence diagram showing a management data collection sequence according to the second embodiment;

FIG. 20 is a block diagram showing the software construction of a parent device of the second embodiment;

FIG. 21 is a block diagram showing the software construction of the management server;

FIG. 22 is a view showing a management configuration after a new parent device is constructed;

FIGS. 23A and 23B are a sequence diagram showing network communications in the second embodiment; and

FIG. 24 is a flowchart showing the internal process implemented by the parent device of the second embodiment.

### DETAILED DESCRIPTION OF THE PREFERRED EMBODIMENTS

The present invention will now be described in detail below with reference to the drawings showing preferred embodiments thereof.

### First Embodiment

Construction of Network System

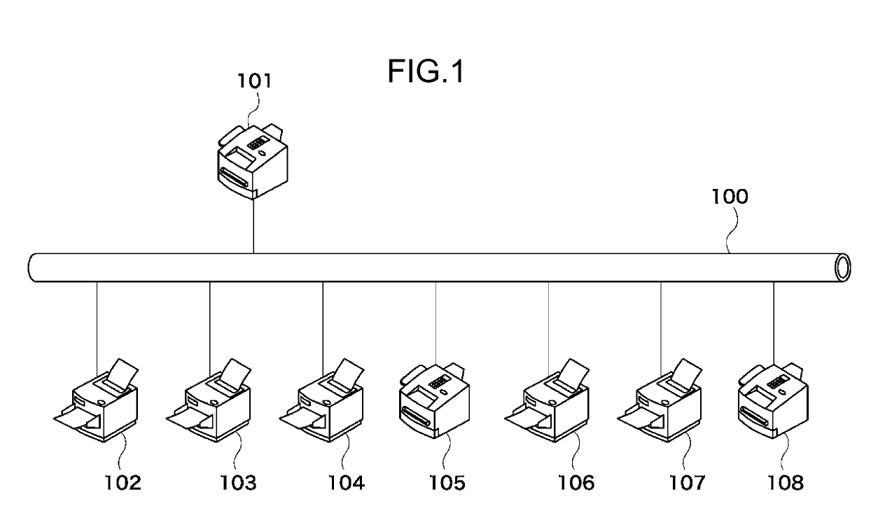

FIG. 1 schematically shows the construction of a network system including devices according to a first embodiment of this invention.

In this embodiment, devices are implemented, for example, by image forming apparatuses. However, the devices in this invention can be implemented by personal computers (hereinafter referred to as PCs) or server apparatuses. A network system is not required to be comprised of devices of the same type. For example, image forming apparatuses, PCs, server apparatuses, etc. may be mixed in the network system.

In the example of FIG. 1, image forming apparatuses 101 to 108 are on a network 100. In this embodiment, it is assumed that the image forming apparatus 101 manages the other image forming apparatuses 102 to 108. Thus, the image forming apparatuses 102 to 108 are subordinative to the image forming apparatus 101. In such an arrangement, a device that realizes the function of the image forming apparatus 101 is called a parent device (management device), and devices that realize the function of the image forming apparatuses 102 to 108 are called child devices (managed devices). In the example of FIG. 1, only the image forming apparatus 101 is a parent device and the other image forming apparatuses are child devices.

It is assumed that unlike other child devices, the child devices 105, 108 each have specs that can realize the function of a parent device. Specifically, the child devices 105 and 108 are each installed with software for managing other devices, which is the same as or similar to software installed in the parent device 101.

Hardware Construction of Image Forming Apparatuses

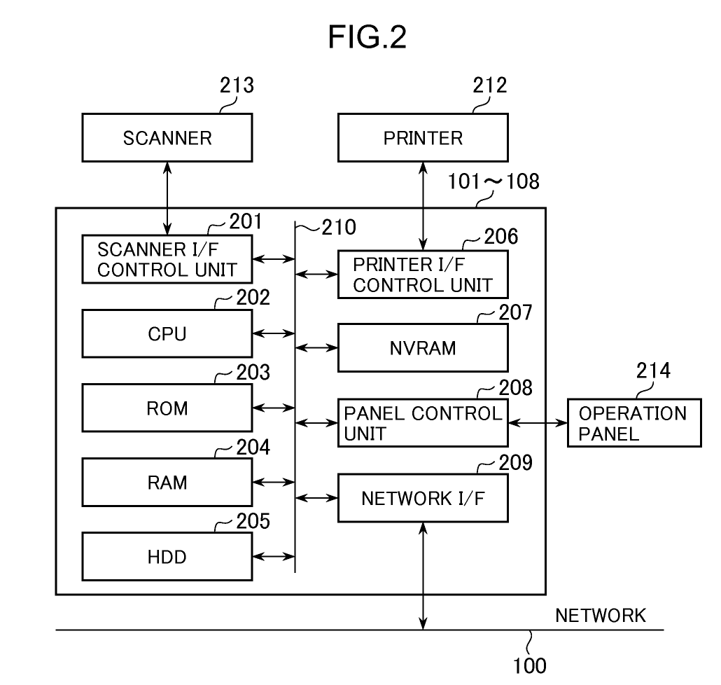

FIG. 2 shows in block diagram the hardware construction of each of the image forming apparatuses 101 to 108 shown in FIG. 1.

The construction described below is common to all the image forming apparatuses without regard to the functions of the parent device and the child device.

Each of the image forming apparatuses 101 to 108 includes various hardware modules connected to a system bus 210. The hardware modules include a scanner I/F control unit 201, a CPU 202, a ROM 203, an HDD 205, a printer I/F control unit 206, an NVRAM 207, a panel control unit 208, and a network I/F control unit 209. Control signals from the CPU 202 and data signals exchanged between the modules are transferred through the system bus 210.

The scanner I/F control unit 201 is adapted to control a scanner 213. The CPU 202 executes a software program for a printing apparatus to thereby control the entire apparatus. The ROM 203 is a read-only memory in which a boot program for the apparatus, fixed parameters, etc. are stored. The RAM 204 is a random-access memory used by the CPU 202 as a temporary data storage, etc. when it controls the apparatus.

The HDD 205 is a hard disk drive used for storage of various data such as print data. The printer I/F control unit 206 has a function of controlling a printer 212. The NVRAM 207 is a non-volatile memory for storing various setting values for the printing apparatus. The panel control unit 208 controls an operation panel 214, displays various information, and inputs user Is instructions. The network I/F control unit 209 controls data transmission and reception to and from the network 100.

Management Data Acquisition Operation in the First Embodiment

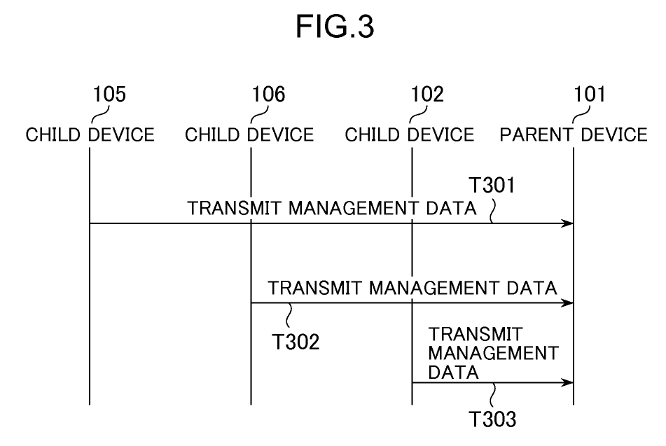

Next, with reference to FIG. 3, a description is given of communications performed by the parent device 101 to manage the child devices 102 to 108 of the network system in FIG. 1.

FIG. 3 shows in sequence diagram communications performed by the parent device 101 to collect management data from the child devices 102, 105 and 106.

Communications denoted by T301 to T303 in FIG. 3 respectively indicate the flows of management data from the child devices 102, 105 and 106 to the parent device 101. As for timings of transmission of management data from the child devices 102, 105 and 106 to the parent device 101, the management data may be regularly transmitted by the polling from the parent device 101 or actively transmitted from the child devices 102, 105 and 106 to the parent device 101.

The management data exchanged between the parent device 101 and the child devices 102, 105 and 106 include status information on the devices, logs on jobs executed by the devices, accounting information held in the devices, program logs for error correction, etc. The management data can further include information on states of use of consumable supplies of the devices, information for notification of abnormality in the devices, etc.

In this embodiment, it is assumed that data exchanged between the parent device 101 and the child devices 102, 105 and 106 are the above described management data. However, image data or other job data may be exchanged therebetween.

In the example of FIG. 3, the management data is transmitted only from the child devices 102, 105 and 106 to the parent device 101. Actually, however, the child devices 103, 104, 107 and 108 also perform similar communications to the parent device 101.

Software Construction in the First Embodiment

(A) Software Construction of Child Devices

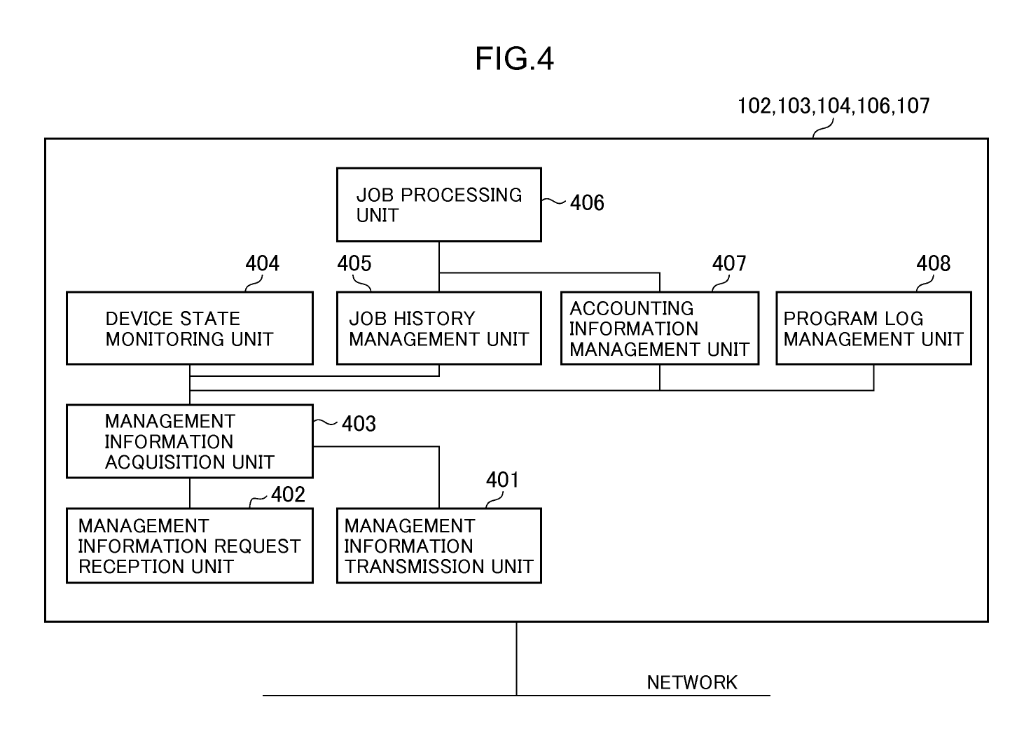

Next, the software construction of devices only operable as child devices is described with reference to FIG. 4.

FIG. 4 shows in block diagram the software construction of the devices 102, 103, 104, 106 and 107 each of which only operates as a child device.

The child devices 102, 103, 104, 106 and 107 transmit data in accordance with a request from the parent device 101. Here, a description is given by taking the child device 102 as representative. The same also applies to the child devices 103, 104, 106 and 107.

The child device 102 includes a device state monitoring unit 404, a job history management unit 405, an accounting information management unit 407, and a program log management unit 408, in which various information are held. The device state monitoring unit 404 monitors a current state of the device and holds information on a main unit of the apparatus and information on options attached to the apparatus. The job history management unit 405 holds history information on a job processed by a job processing unit 406. The accounting information management unit 407 holds accounting information on the job processed by the job processing unit 406. The program log management unit 408 holds log information in which a software processing process is recorded. These are example information held in the device of this embodiment, but other information may be held therein.

In the child device 102, a management information request reception unit 402 receives from the parent device 101 a request for transmission of the management information, and a management information acquisition unit 403 acquires information held by the device state monitoring unit 404, the job history management unit 405, the accounting information management unit 407, the program log management unit 408, etc. The thus acquired information is delivered to a management information transmission unit 401. The transmission unit 401 prepares a network message including, as management data, the information delivered from the acquisition unit 403 and transmits the network message to the parent device 101.

(B) Software Construction of the Parent Device

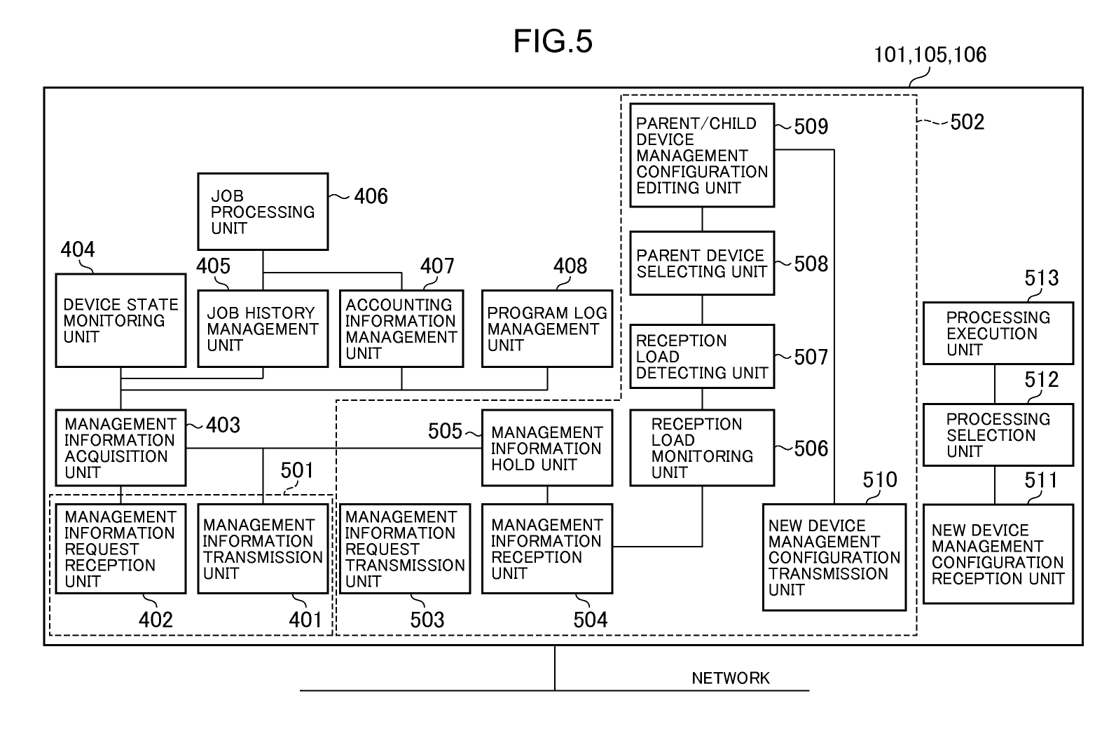

Next, the software construction of devices each able to serve as a parent device is described with reference to FIG. 5.

FIG. 5 shows in block diagram the software construction of the devices 101, 105 and 108 each of which is capable of serving as a parent device.

Each of the devices 101, 105 and 108 is able to upgrade itself from a child device to a parent device in accordance with user's or administrator's setting or a request by other device. The device upgraded to a parent device not only manages information on its own but also manages information on other child devices. In the following, an example case where the device 101 serves as a parent device is described. The same also applies to the devices 105 and 108.

The device 101 has a software construction that is an expansion of the above described software construction of child device. The parent device 101 includes the units 401 to 408 provided in the child device that is characterized by a processing system 501 including the units 401 and 402. The parent device 101 is characterized in that a processing system 502 is added and the processing systems 501 and 502 are switched, where required.

The processing system 502 is adapted to issue a request for transmission of management data to child devices and store received management data. To this end, the processing system 502 includes a management information request transmission unit 503, a management information reception unit 504, a management information hold unit 505, a reception load monitoring unit 506, and a reception load detecting unit 507. The processing system 502 further includes a parent device selecting unit 508, a parent/child device management configuration editing unit 509, and a new device management configuration transmission unit 510.

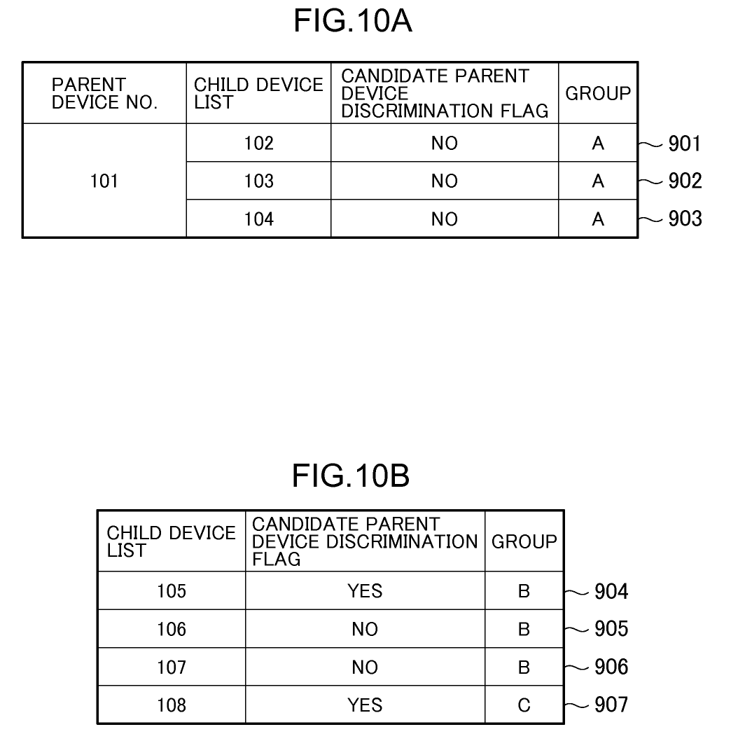

The management information request transmission unit 503 regularly or irregularly transmits a management data request message to child devices set in the own device. Objects to which the management data request is transmitted are decided based on lists held by the parent device 101 and shown in FIGS. 9A and 9B. The lists in FIGS. 9A and 9B will be described later.

When management data is transmitted from any of the child devices to which the management data request has been transmitted, the management information reception unit 504 receives the transmitted management data which is then held in the management information hold unit 505 on a per child device basis. The management information hold unit 505 also holds the management data regarding the parent device 101, which is acquired from the management information acquisition unit 403. The management information hold unit 505 may be provided in a non-volatile region such as the HDD 205 or the NVRAM 207 or in a volatile region such as the RAM 204.

This embodiment is characterized by the reception load detecting unit 507, the parent device selecting unit 508, the parent/child device management configuration editing unit 509, and the new device management configuration transmission unit 510. In the network system construction of this embodiment, these units operate to automatically change the management configuration of the parent and child devices and restore the original management configuration, as described in detail later.

User Interface

Next, a description is given of a user interface used for the devices in this embodiment.

The user interface is used by the user or the administrator to change the setting or refer to the setting. The user interface may be a screen (operational panel 214) attached to the body of each of the devices, or may be displayed via the network on a screen provided outside the device.

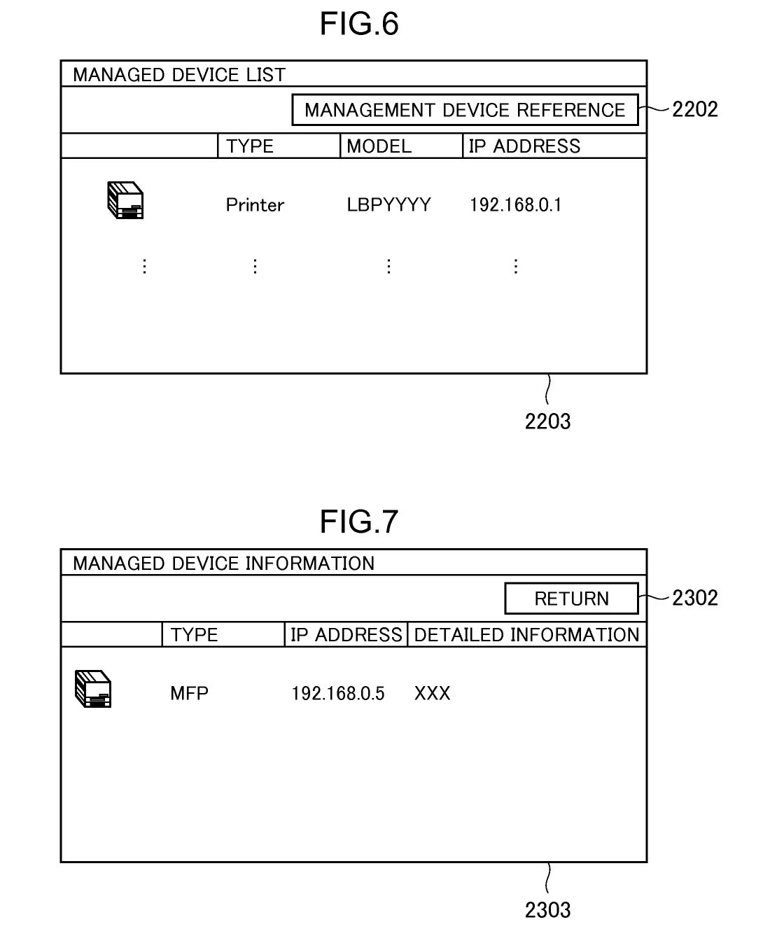

FIG. 6 shows an example screen displayed on the operation panel 214 of the parent device 101 in this embodiment. The screen is adapted to display, in list form, information on child devices managed by the parent device 101.

The information on the child devices managed by the parent device 101 are displayed on a screen 2203. In this example, types of devices, model names, and IP addresses are displayed. However, other information on the child devices may be displayed. The information displayed on the screen 2203 relates to the devices shown in a management object list 601 described later with reference to FIG. 9A.

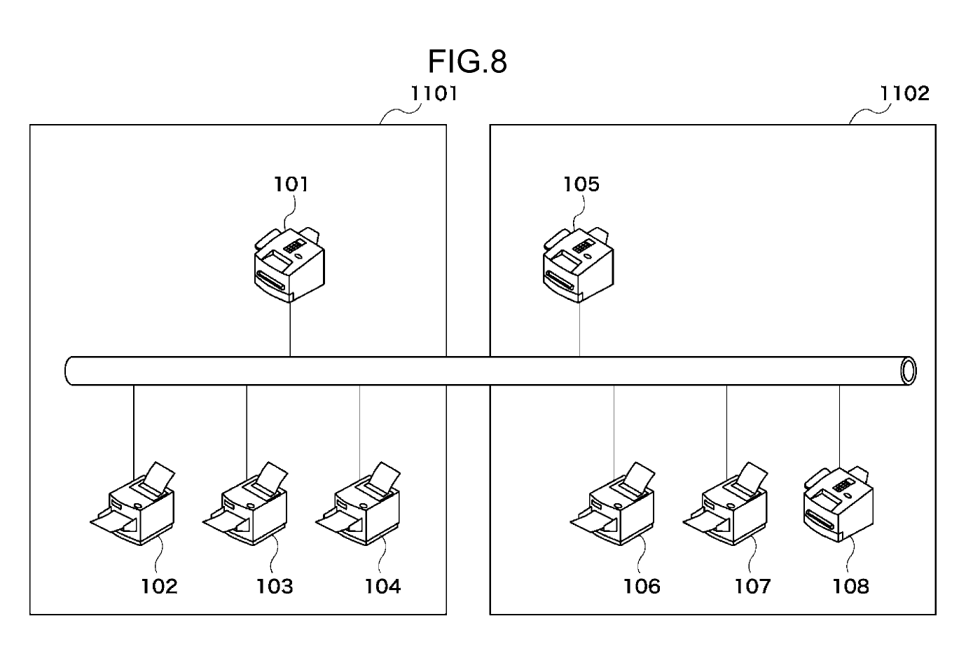

By depressing a button 2202, the user or the administrator is able to display a screen shown in FIG. 7 for showing information on a device upgraded to a parent device by the user or the administrator.

FIG. 7 shows another example screen displayed on the operation panel 214 of the parent device 101 in this embodiment. Information on a device upgraded to a parent device by the parent device 101 is displayed on the screen.

A return button 2302 is for returning to the original screen shown in FIG. 6. On the screen 2303, there are displayed the type, the IP address, and the detail information on the device upgraded to a parent device. Other information may be displayed thereon. A relation between the parent device upgraded and child devices may be displayed. Furthermore, the current management configuration on the network may automatically be acquired and displayed in a form in which a master-servant relationship between parent device and child devices is indicated.

Autonomous Operation to Change the Management Configuration

Next, a description is given of an operation of automatically changing and restoring the management configuration of parent and child devices in the network system construction, by which this embodiment is characterized.

(A) Configuration Changing Operation at Load Distribution

The reception load monitoring unit 506 of the parent device 101 monitors the management information reception unit 504, and the reception load detecting unit 507 detects a load state of the parent device 101. The load state represents, for example, the increase in traffic of the network, the increase in load caused by execution of a job inside or outside the device, etc.

When a high load state is detected by the reception load detecting unit 507, the parent device selecting unit 508 selects a candidate for parent device from the list shown in FIG. 9A. Then, the parent/child device management configuration editing unit 509 prepares new lists indicating a new parent device and its subordinate child devices. In the following description, it is assumed that the device 105 is newly selected as the parent device. The high load state may be determined by determining whether or not a threshold value (reference value) of load which is held beforehand in the parent device 101 is exceeded. In that case, the reference value is held beforehand in a storage unit of the parent device 101. The reference value may be one which can arbitrarily be changed by the user or the administrator. Alternatively, the high load state may be determined when it is determined by comparison that the load on the own device is higher than that on other devices (child devices). The high load state may not be determined based on numeric load value, but may be determined by determining whether or not predetermined one or more processes are being executed.

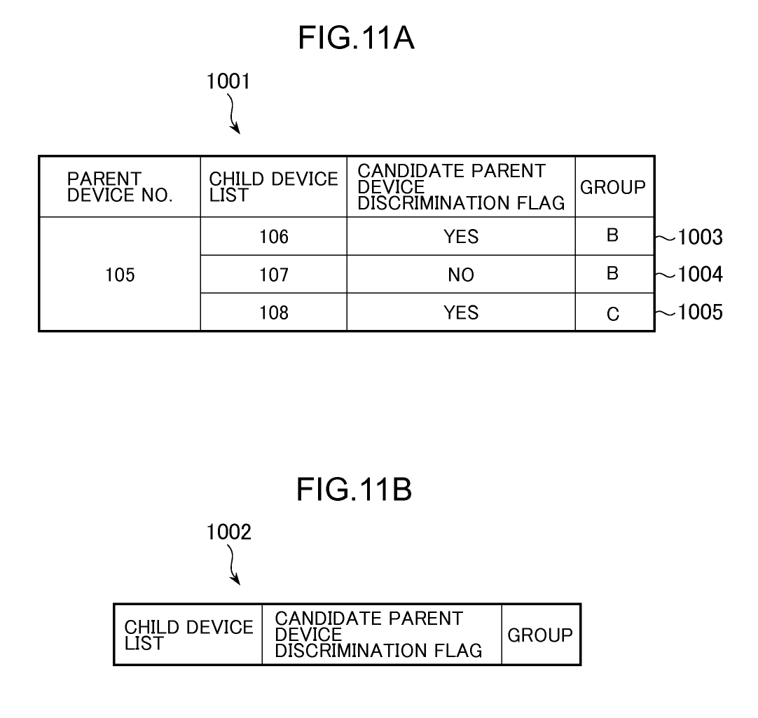

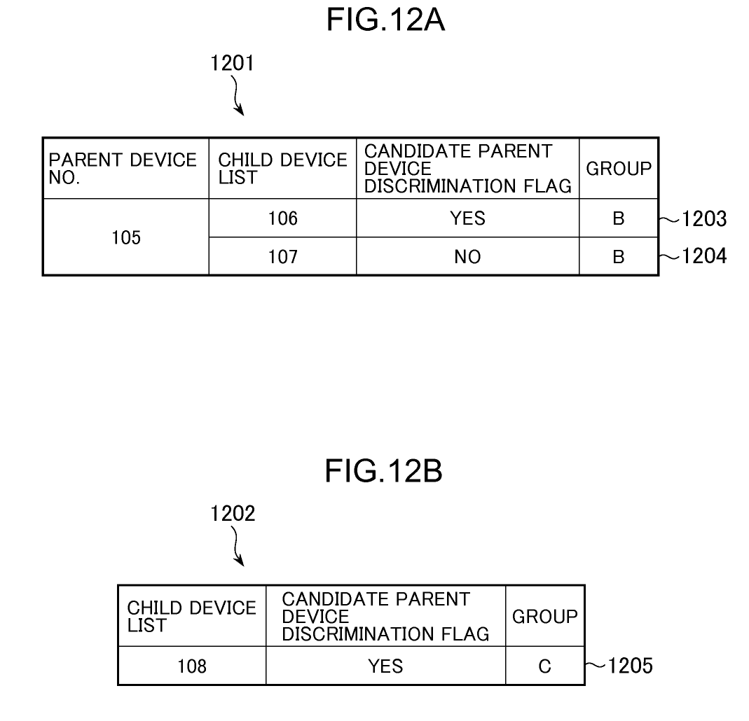

After the preparation of the new lists for the new parent device 105, the lists indicating child devices managed and unmanaged by the parent device 101 are edited as shown in FIGS. 10A and 10B, and the lists indicating child devices managed and unmanaged by the new parent device 105 are edited as shown in FIGS. 11A and 11B. The lists in FIGS. 10A, 10B, 11A and 11B will be described later.

The edited lists are transmitted by the new device management configuration transmission unit 510 to the device 105, i.e., the new parent device. In the new parent device 105, the lists are received by the new device management configuration reception unit 511, and the processing system 502 is selected by the processing selection unit 512. The processing system 501 is switched to the processing system 502 by the processing execution unit 513 of the new parent device 105, and an operation similar to the internal process in the parent device 101 is started. The internal process in the parent device will be described in detail later.

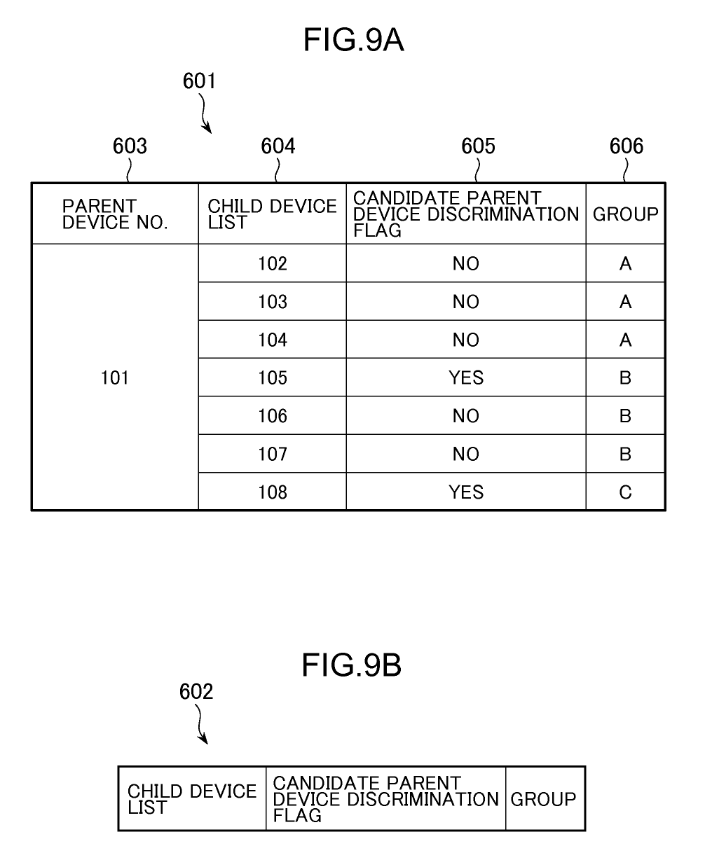

After the device previously operating as a child device is newly upgraded to a parent device, management ranges are defined as shown in FIG. 8. FIG. 8 schematically shows the management ranges after the execution of load distribution according to the first embodiment.

The example shown in FIG. 8 indicates that the parent device 101 manages the child devices 102 to 104 in a managed range 1101 and the new parent device 105 manages the child devices 106 to 108 in a managed range 1102.

In the following, managed/unmanaged child device lists held by the parent device and a list edit operation performed when a child device is upgraded to a parent device are described with reference to FIGS. 9A to 11B.

In this embodiment, child devices are managed in accordance with the illustrated lists, but list constructions are not limited to the illustrated ones. The list construction may be changed using network communication as required, and the lists are not essentially required to be provided in devices. The lists may be manually set by the user or the administrator, or by automatically exchanging information via the network from the parent device or from the child device.

Lists Held by the Parent Device

FIGS. 9A and 9B show, in table diagram, lists held by the parent device.

The parent device holds a list 601 indicating child devices to be managed by the parent device, and a list 602 indicating child devices which are no longer to be managed by the parent device due to the increase in load or the like.

The list 601 includes an entry 603 for a parent device number that specifies the parent device, and an entry 604 for a child device list that holds identifiers of child devices to be managed by the parent device. The identifiers may be, for example, IP addresses, domain names, character strings input by the user, or the like. In FIG. 9A, for convenience of explanation, the identifiers are reference numerals in FIG. 1 that denote the devices concerned. On the other hand, the list 602 includes a child device list indicating devices to which the parent device does not issue a request for transmission of management data.

The list 601 includes an entry 605 for candidate parent device discrimination flags, each of which is set to YES if a corresponding child device is a candidate parent device, and set to NO if it is not a candidate patent device. Each flag information (YES or NO) can be manually set by the user or the administrator, or can be automatically determined by the parent device or reported by the corresponding child device during exchange of management data or according to a result of data exchange.

The list 601 also includes an entry 606 for child device groups. As described above, when the load on the parent device increases, a new parent device is selected for load distribution. In this regard, the association between the parent device and the lists 601, 602 is changed (the lists 601, 602 are modified). The lists 601, 602 are modified in units of a child device group. Each group must include a candidate for parent device. The division of the child devices into groups can be set by the user or the administrator or automatically determined by the parent device.

Lists Held by the Parent Device 101 after the Load distribution

FIGS. 10A and 10B show, in table diagram, lists held by the parent device 101 after the load distribution. The illustrated lists are ones held by the parent device 101 after the device 105 is upgraded from a child device to a parent device.

In this embodiment, as shown by entries 901 to 903 in FIG. 10A, the list 601 (FIG. 9A) for the parent device 101 is modified at the load distribution such that the parent device 101 manages only the child devices 102 to 104 belonging to group A. On the other hand, the list 602 for the parent device 101 is modified such that the new parent device 105 manages the child devices 106 to 108 belonging to groups B and C, as shown by entries 904 to 907 in FIG. 10B. Specifically, the child devices 105 to 108 previously associated with the managed child device list 601 (FIG. 9A) are associated with the unmanaged child device list (FIG. 10B).

Lists Held by the New Parent Device 105 after the Load Distribution

FIGS. 11A and 11B show, in table diagram, lists held by the new parent device 105 after the load distribution.

The illustrated lists are ones held by the device 105 upgraded from a child device to a parent device, i.e., the new parent device 105. Like the lists for the parent device 101 which are shown in FIGS. 9A and 9B, the illustrated lists are comprised of a managed child device list 1001 and an unmanaged child device list 1002. The list 1001 only includes the child devices (other than the device 105) indicated in the unmanaged child device list 602 held by the parent device 101.

Entries 1003 to 1005 in the list 1001 respectively correspond to the entries 905 to 907 in FIG. 10B.

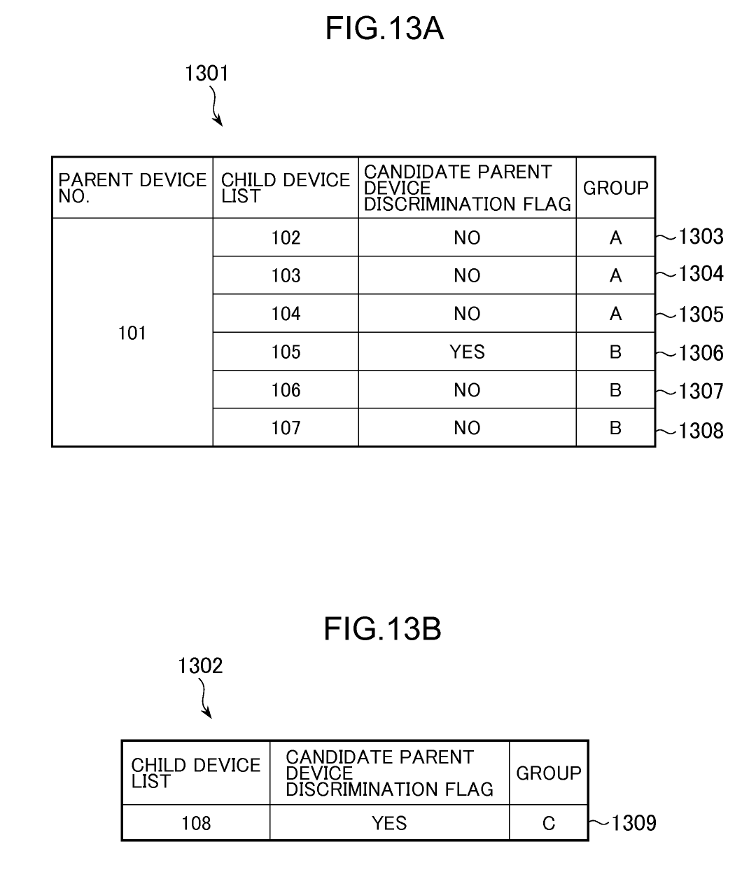

As with the parent device 101, the new parent device 105 is able to upgrade another child device to a parent device depending on its own load state. An upgrade process is the same as the upgrade process previously described. When the parent device 105, which has been upgraded to a new parent device at the load distribution, upgrades another child device 108 to a parent device at load redistribution, the lists 1001, 1002 are modified as shown in FIGS. 12A and 12B.

FIGS. 12A and 12B show, in table diagram, lists held by the parent device 105 after the load redistribution.

After the load redistribution, the parent device 105 holds a managed child device list 1201 shown in FIG. 12A and an unmanaged child device list 1202 shown in FIG. 12B. Entries 1203 and 1204 in the list 1201 indicate child devices to be managed by the parent device 105. An entry 1205 in the list 1202 indicates a child device which is no longer to be managed by the parent device 105. In the illustrated example, the list 1202 only includes one child device 108 belonging to group C. Depending on cases, there are a plurality of child devices in the list or there is no child device in the list. In a case that there is no subordinate child device of the parent device, the parent device only collects its own information.

(B) Operation for Restoration of Configuration

Next, a description is given of an operation for restoring the original state of a device, which has been upgraded from a child device to a parent device at load distribution. The operation for restoration of configuration is basically the same as the operation at load distribution for upgrading a child device to a parent device, but differs therefrom in that the reception load detecting unit 507 of the parent device 101 in FIG. 5 does not detect increase in load but detects reduction in load and that the new device management configuration transmission unit 510 notifies lists restored from the lists shown in FIGS. 10A to 11B and held by the parent device and the new parent device.

When the reception load detecting unit 507 of the parent device 101 detects a reduction in load state of the parent device 101, the parent device selecting unit 508 selects the device 105 upgraded to a parent device at the load distribution. A reduction in load state is detected, for example, when it is detected that any of child devices enters a sleep state or issues a shut-down request.

Then, the lists shown in FIGS. 10A and 10B after load distributions are edited to the lists shown in FIGS. 9A and 9B by the parent/child device management configuration editing unit 509, and the resultant new lists are transmitted from the new device management configuration transmission unit 510 to the parent device 105.

In the parent device 1057 the new device management configuration reception unit 511 receives the new lists, the processing selection unit 512 selects the processing system 501, and the processing execution unit 513 changes the processing from the processing system 502 to the processing system 501. As a result, the device 105 stops its operation as the parent device.

At that time, if the parent device 105 holds the lists shown in FIGS. 12A and 12B after load redistribution, i.e., if the parent device 105 has upgraded the child device 108 to a parent device, the parent device 105 carries out the following process.

As with the above described subordination process implemented by the parent device 101, the parent device 105 causes the device 108 to be subordinate to the device 105, and then returns itself to a child device of the device 101.

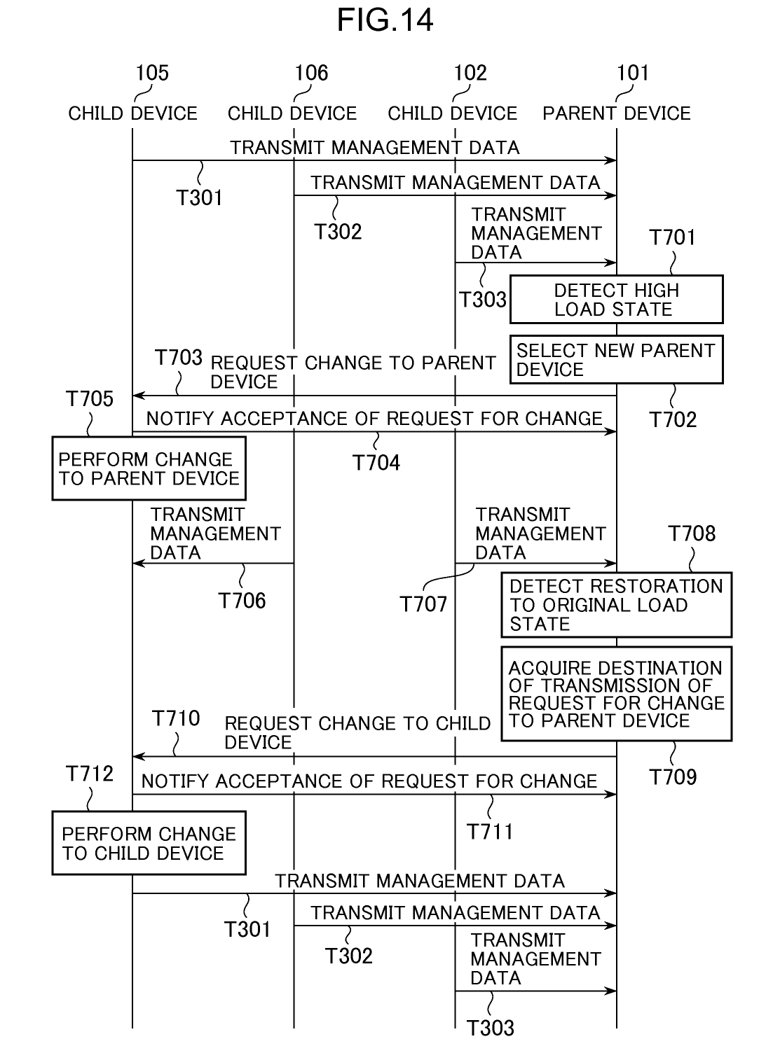

Alternatively, the device 105 notifies the parent device 101 that the device 108 is in a state where it operates as a parent device, and then causes the devices of group B to be subordinate to the parent device 101. The resultant lists for the parent device 101 are ones in FIGS. 13A and 13B which show, in table diagram, example lists held by the parent device 105 after restoration from the configuration set at the load redistribution. Lists 1301, 1302 in FIGS. 13A and 13B show the list configuration set when the parent device 105 returns to a child device. The child devices 102 to 104 indicated in entries 1303 to 1305 of the list 1301 are originally managed by the parent device 101. The indication of the child devices 105 to 107 in entries 1306 to 1308 represents that the parent device 105 and the child devices 106, 107 previously managed by the parent device 105 are returned to be under management of the parent device 101. The device 108 shown in an entry 1309 of the list 1302 currently operates as a parent device, and is not under the management of the parent device 101.

Network Communication in the First Embodiment

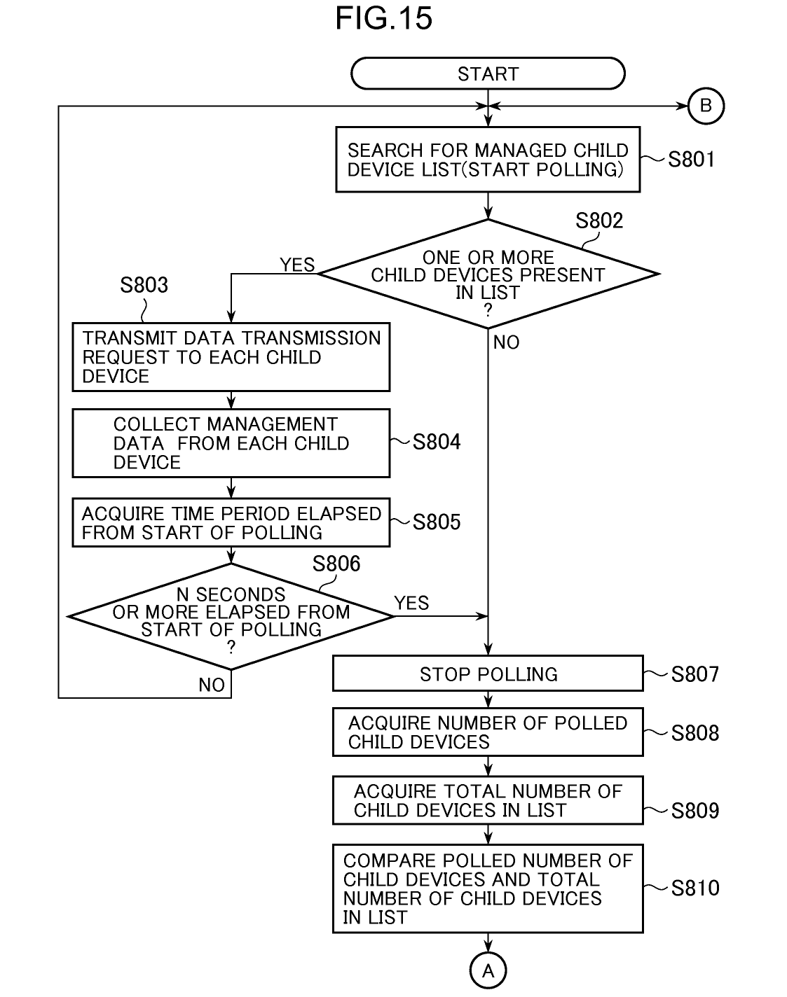

Next, with reference to FIG. 14, a network communication sequence for autonomous operation to change the management configuration is described.

FIG. 14 shows, in sequence diagram, communications at the time a child device is upgraded to a parent device and communications at the time the parent device is downgraded to the child device.

In FIG. 14, T301 to T303 represent the normal management data acquisition sequence already described with reference to FIG. 3.

When detecting an increase in its own load (T701), the parent device 101 selects a new parent device (T702). Assuming that the device 105 is selected as with the above described example, the parent device 101 transmits to the child device 105 a notification requesting the child device 105 to change to a parent device (T703).

When receiving the notification from the parent device 101, the child device 105 examines its own load state, and in accordance with a result of the examination, selects whether or not the upgrade to a parent device should be accepted. If it is selected to become a parent device, the child device 105 transmits a notification to the parent device 10 that it accepts to become a parent device (T704). To become a parent device, the child device 105 changes the processing system from the processing system 501 to the processing system 502 (T705), and starts its operation as the parent device.

As a result, the child device 106 transmits its management data to the new parent device 105 (T706), and only the child device 102 transmits its management data to the original parent device 101 (T707).

Subsequently, when the parent device 101 determines that its own load state returns to its original load state (T708), the parent device 101 identifies the device 105 previously updated to the parent device (T709), and transmits to the device 105 a request to return to a child device (T710).

When the receiving the request, the new parent device 105 selects whether or not the request to change to a child device should be accepted. If the change to a child device is selected, the new parent device 105 transmits to the parent device 101 a notification to accept the change (T711), stops the operation as the parent device, and returns to the child device (T712). Thereafter, the original communication state shown by T301 to T303 is restored.

Internal Process by the Parent Device

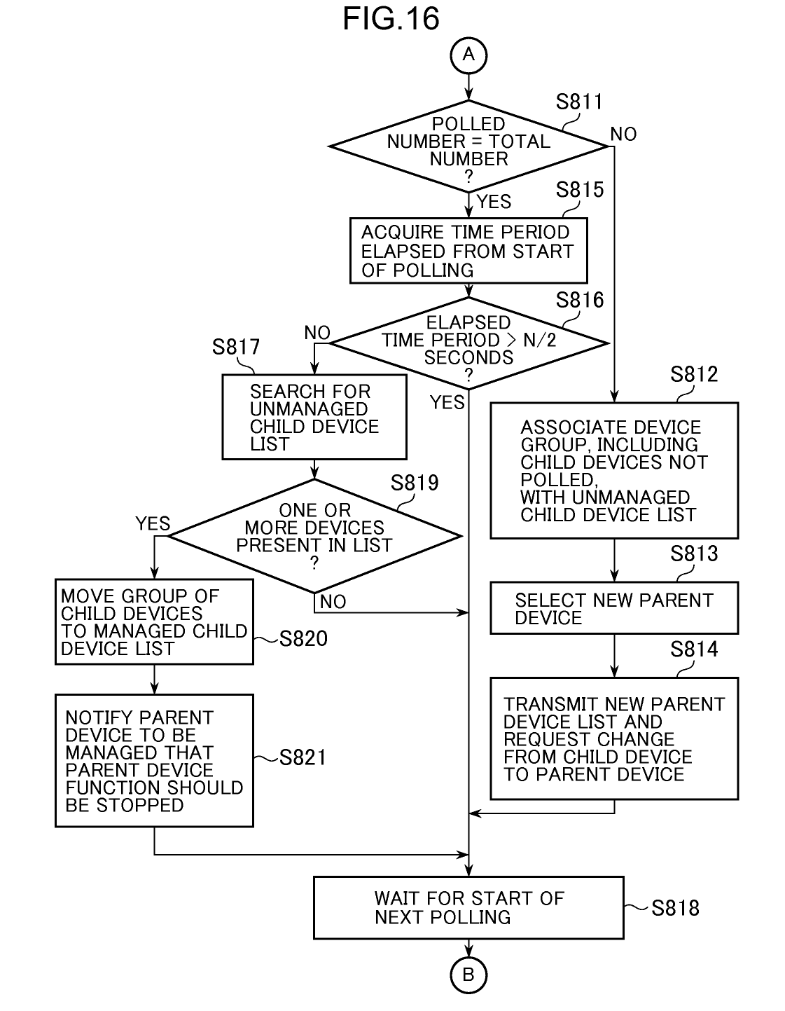

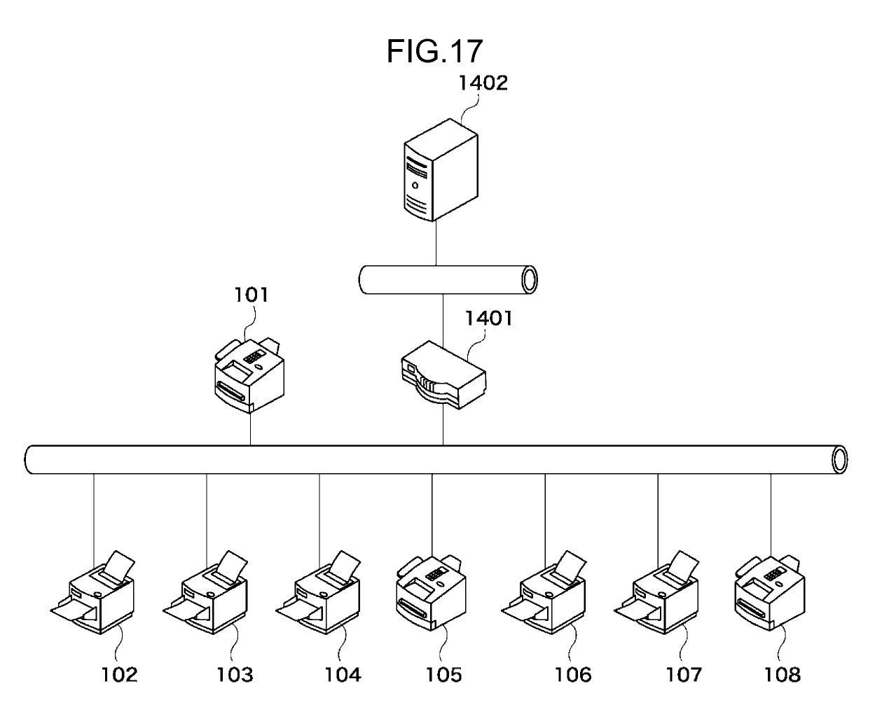

Next, with reference to FIGS. 15 and 16, an example internal process implemented by the parent device for the network communication is described. FIGS. 15 and 16 show in flowchart the internal process by the parent device.

In the example, the term “polling” represents processing in which the parent device requests child devices to transmit management data.

The management information request transmission unit 503 searches for the managed child device list in S801, and determines in S802 whether or not one or more child devices are present in the managed child device list. If it is determined that there is no child device in the list, the management information request transmission unit 503 stops polling in S807. On the other hand, if it is determined in S802 that there are one or more child devices in the list, the management information request transmission unit 503 transmits a data transmission request to each child device in S803, and the management information reception unit 504 acquires data from each child device in S804.

Next, the reception load monitoring unit 506 acquires in S805 a time period required for the data acquisition from the one or more child devices, and the reception load detecting unit 507 determines in S806 whether or not the data acquisition time period is equal to or longer than a predetermined time period (N seconds). The polling is stopped upon elapse of the predetermined time period from the start of the polling, but is continued until the elapse of the predetermined time period.

If the management information request transmission unit 503 stops the polling in S807, the reception load detecting unit 507 acquires in S808 a total number of child devices polled up to that time, and acquires in S809 a total number of child devices in the list. The reception load detecting unit 507 compares in S810 the acquired total numbers with each other, and determines in S811 whether or not the polling process has been completed for all the child devices in the list.

If it is determined that the polling process has been completed for all the child devices, the reception load detecting unit 507 acquires in S815 a time period elapsed from the start of the polling, and compares in S816 the elapsed time period with the predetermined time period to thereby determine whether or not the elapsed time period is sufficiently smaller than the predetermined time period. In this example, whether or not the elapsed time period is smaller than, e.g., half of N seconds is determined.

If it is determined that the elapsed time period is sufficiently smaller than the predetermined time period (not larger than half of N seconds), the parent device 101 determines a reduction in its own load and executes processing to restore the management configuration in S817 to S821.

Specifically, the parent/child device management configuration editing unit 509 searches for the unmanaged child device list in S817 and determines in S819 whether or not one or more devices are present in the unmanaged child device list. If there is no device in the list, processing to wait for the start of the next polling is entered in S818. On the other hand, if there are one or more devices in the unmanaged child device list, the parent/child device management configuration editing unit 509 selects one group of child devices from the unmanaged child device list and moves the selected group to the managed child device list in S820. In S821, the new device management configuration notification unit 510 transmits the managed child device list to a device to be changed from a parent device to a child device, and in S818 the processing to wait for the start of the next polling is entered.

On the other hand, if it is determined in S811 that the total number of polled child devices is less than the total number of child devices in the managed child device list, the parent device 101 determines an increase in its own load and executes processing to configure a new patent device in S812 to S814, to thereby deconcentrate the management performed by the parent device on child devices.

Specifically, in S812, the parent/child device management configuration editing unit 509 associates child devices which cannot be polled in the current processing cycle with the unmanaged child device list. In S813, the parent device selecting unit 508 selects a new parent device. In S814, the parent device selecting unit 508 cooperates with the parent/child device management configuration editing unit 509 to reconfigure the managed and unmanaged child device lists, and the new device management configuration transmission unit 510 transmits the reconfigured lists to the new parent device. Then, the processing to wait for start of the next polling is entered in S818.

In S806, N seconds measured from the start of 5 polling are used as a prescribed value at which the polling is forcibly completed, but the prescribed value may be a number of times the process cycle is executed. In S816, the time period set to half of N seconds is used as a criterion to restore entries associated with the unmanaged child device list. This is a mere example of the criterion, and the criterion may be another threshold value. In the above example, a case has been described in which the parent device acquires log information from child devices, but information to be acquired therefrom may not be log information.

Advantages of the First Embodiment

According to the first embodiment, the management configuration of the network system including parent and child devices can autonomously be modified. Specifically, the number of parent devices can dynamically be increased when the load on the original parent device increases, to thereby deconcentrate the management performed by the original parent device on child devices. In addition, the original management configuration can automatically be restored when the load on the original parent device decreases, thereby reducing the burden on the user or the administrator of the devices and the network administrator.

### Second Embodiment

Next, another embodiment of this invention is described. In the following description of this embodiment, points different from the first embodiment are only described, with a description of points which are same as or similar to the first embodiment omitted.

Construction of a Network System in the Second Embodiment

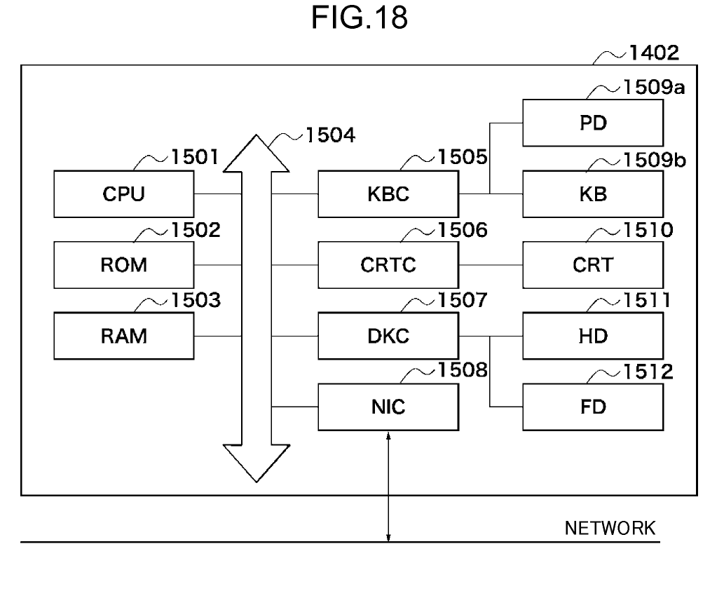

FIG. 17 schematically shows the construction of a network system including devices according to the second embodiment of this invention. Devices 101 to 108 are the same in function as those of the first embodiment. Thus, the device 101 as a parent device is adapted to collect information on the child devices 102 to 108.

In this embodiment, the parent device 101 collects management data on the child devices, and transmits the collected data to a management server 1402. The management server 1402 is adapted to collect management data on all the devices on the network and manage the collected management data.

In this embodiment, the parent device detects its own load state, but the lists described in the first embodiment with reference to FIGS. 9A and 9B are held by the management server 1402. The management server 1402 edits the lists and notifies the edited lists to a new parent device to thereby upgrade a child device to a parent device.

It is assumed that the management server 1402 is a PC, but the server 1402 may be an image forming apparatus or other apparatus. In this embodiment, a router 1401 is disposed between the management server 1402 and the devices 101 to 108. However, the network system may not have the router. The management server 1402 may not be disposed on the LAN but on the Internet.

Hardware Construction of the Management Server

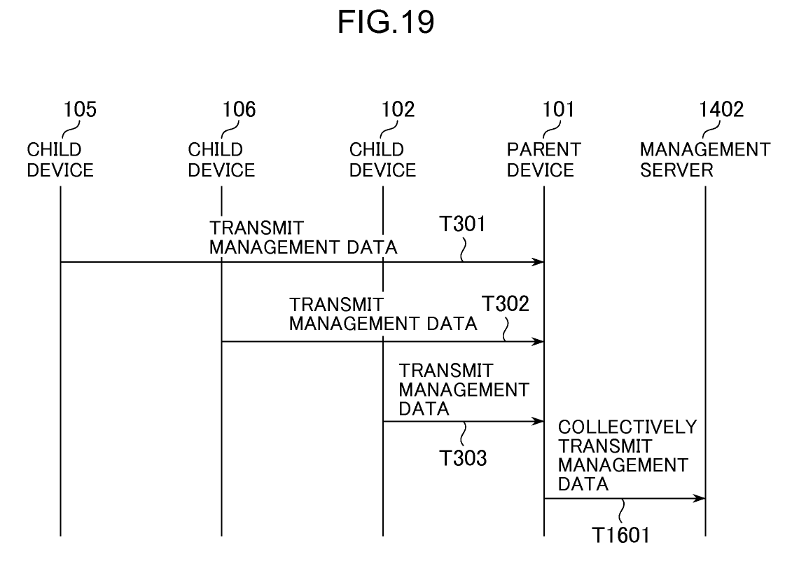

Next, with reference to FIG. 18, the hardware construction of the management server 1402 is described, assuming that the server 1402 is a PC.

FIG. 18 shows, in block diagram, the hardware construction of the management server 1402.

As shown in FIG. 18, the management server 1402 includes a CPU 1501, a ROM 1502, and a RAM 1503, which are connected to a system bus 1504. A keyboard controller (KBC) 1505, a display control unit (CRTC) 1506, a disk controller (DKC) 1507, and a network interface card (NIC) 1508 are also connected to the system bus 1504.

The CPU 1501 controls various devices connected to the system bus 1504. The ROM 1502 stores a BIOS and a boot program, and the RAM 1503 is used as a main storage unit of the CPU 1501.

The keyboard controller (KBC) 1505 performs processing, for example, to input information from a pointing device 1509a such as a mouse (registered trademark) and from a keyboard 1509b. The display control unit (CRTC) 1506 has an internal video memory, draws image data on the video memory in accordance with an instruction from the CPU 1501, and outputs, as video signals, the image data drawn on the video memory to a CRT display unit 1510. In FIG. 18, as a display unit, the CRT display unit 1510 is shown by way of example, but the display unit may be a liquid crystal display unit or any other display unit.

The disk controller (DKC) 1507 accesses a hard disk 1511 and a floppy (registered trademark) disk 1512. In the hard disk 1511, an OS (Operating System), various application programs, etc. are stored. The network interface card (NIC) 1508 is connected to the network, and performs information communication via the network.

With the above construction, when power supply to the apparatus is turned ON, the CPU 1501 reads the OS from the hard disk 1511 into the RAM 1503 in accordance with the boot program stored in the ROM 1502. As a result, the CPU 1501 is able to function as an information processing apparatus.

Management Data Acquisition Operation in the Second Embodiment

Next, a sequence to acquire the management data is described.

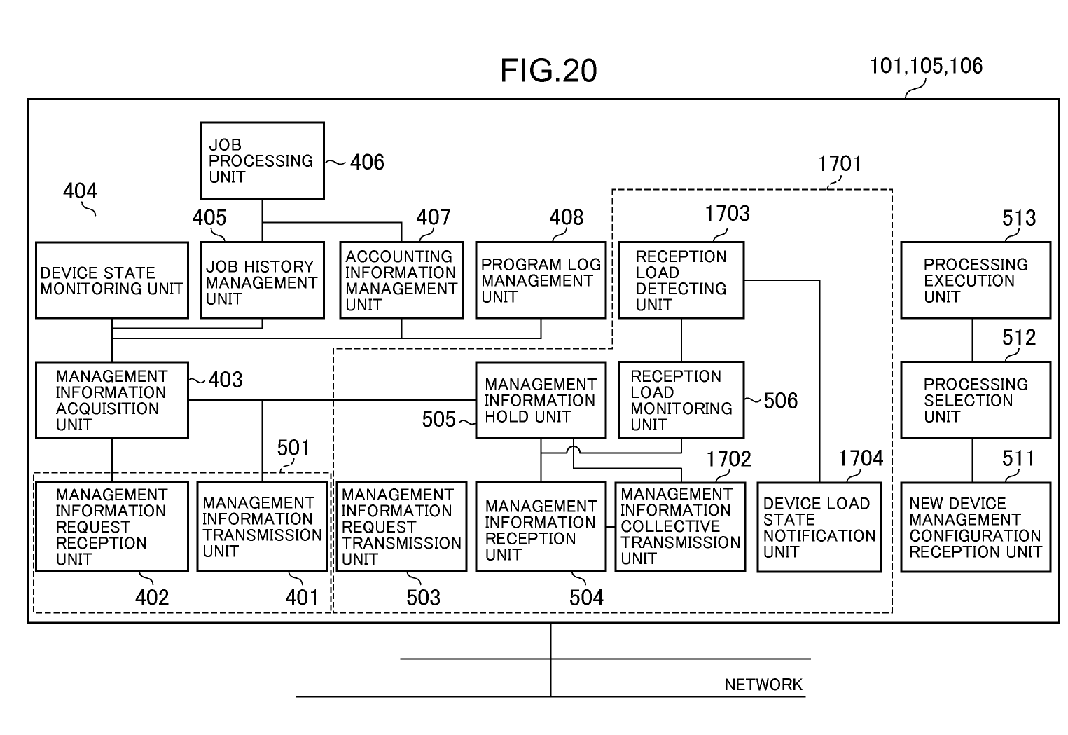

FIG. 19 shows, in sequence diagram, a management data acquisition sequence in this embodiment.

In this embodiment, apparatuses to be sequenced include not only the parent and child devices 101, 102, 105 and 106 shown in FIG. 3, but also the management server 1402. In the example shown in FIG. 19, the management data on the child devices 102, 105 and 106 collected by the parent device 101 are transmitted to the management server 1402 (T1601).

Software Construction in the Second Embodiment

Next, a description is given of the software construction of the devices 101, 105 and 108 each able to become a parent device and the management server 1402 in this embodiment. The software construction of child devices which are unable to become a parent device is the same as that described with reference to FIG. 4. In the following description, the device 101 is taken as representative of the parent device. The same applies to the devices 105 and 108.

(A) Software Construction of the Parent Device

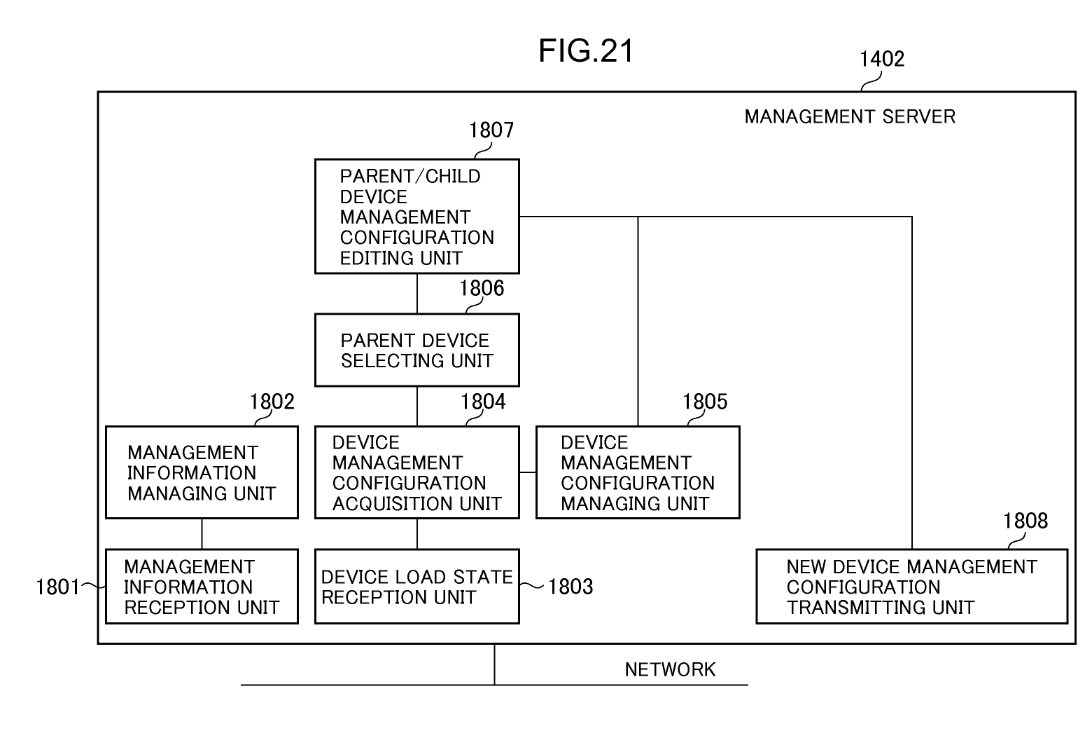

FIG. 20 shows, in block diagram, the software construction of the parent device 101 of the second embodiment.

The software construction is basically the same in operation as that shown in FIG. 5. Processing as either a child device or a parent device is selected by switching between processing systems 501 and 1701. As with the device shown in FIG. 5, when the processing system 501 operates, the device 101 operates as a child device. On the other hand, when the processing system 1701 operates, the device 101 operates as a parent device.

The processing system 1701 is somewhat different from the processing system 502 of FIG. 5 in that a management information collective transmission unit 1702 is added to the processing system 1701 and the units 508, 509 to select a parent device and edit the management lists are not provided in the processing system 1701. The management information collective transmission unit 1702 has a function of transmitting management data on child devices stored in the management information hold unit 505 to the management server 1402.

The selection of parent device and editing of management lists are carried out on the side of the management server 1402. When wishing to upgrade some device to a parent device, the parent device 101 transmits a notification to that effect to the management server 1402 via a device load state notification unit 1704.

(B) Software Construction of the Management Server 1402

Next, a description is given of the management server 1402 for receiving the notification transmitted from the device load state notification unit 1704. In this embodiment, it is assumed that the management server 1402 holds on a per parent device basis the lists shown in FIGS. 9A and 9B. As described in the first embodiment, the form of the lists are not limited to those of FIGS. 9A and 9B. The management server 1402 may not have the lists, but can acquire list information on the network, where required.

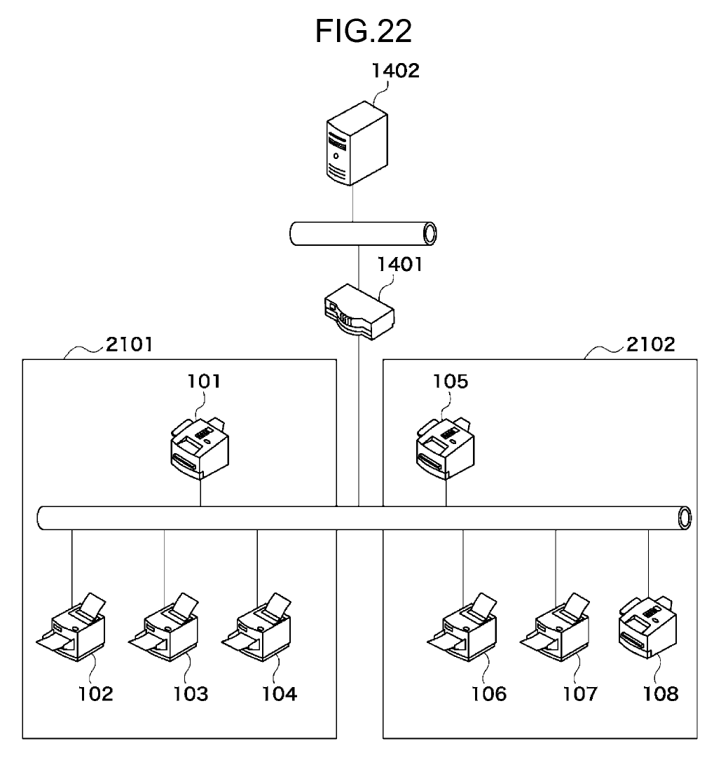

FIG. 21 shows, in block diagram, the software construction of the management server 1402.

As shown in FIG. 21, the management server 1402 includes a management information reception unit 1801 that receives management data transmitted from the management information collective transmission unit 1702 of the parent device. The received management data is held and managed by a management information managing unit 1802.

The notification transmitted from the device load state notification unit 1704 in FIG. 20 is received by a device load state reception unit 1803 in FIG. 21. In response to the notification, a device management configuration acquisition unit 1804 acquires the lists shown in FIGS. 9A and 9B, and a parent device selecting unit 1806 selects a child device able to become a parent device from child devices indicated in the lists.

A parent/child device management configuration editing unit 1807 prepares new lists based on a result of the selection. The prepared new lists are held in a device management configuration managing unit 1805 and notified from a new device management configuration transmitting unit 1808 to the device 105 selected as the new parent device. Subsequently, an operation to upgrade the device 105 to a parent device is carried out in the same manner as described in the first embodiment.

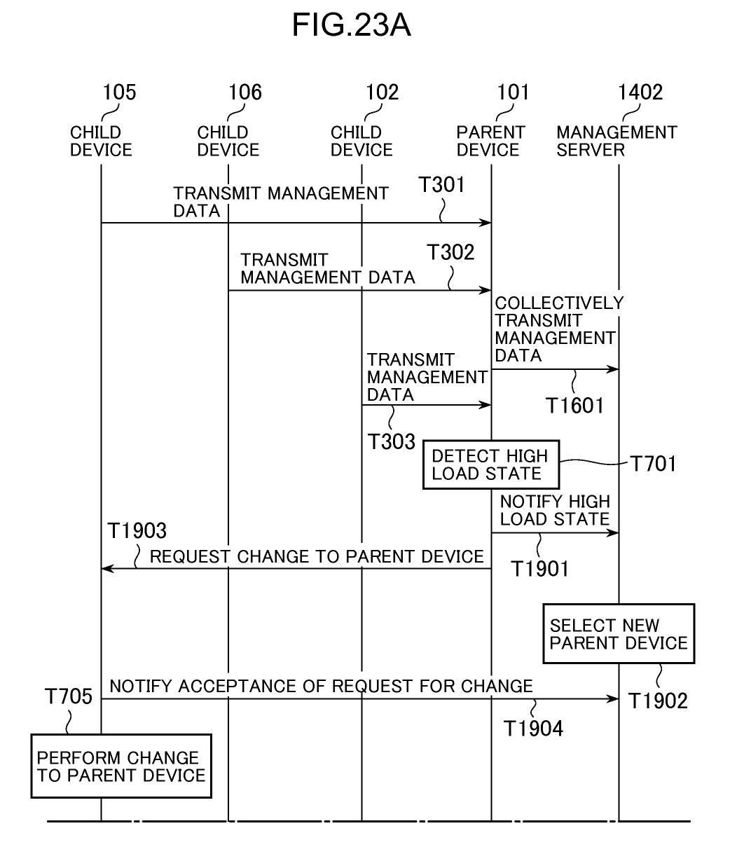

FIG. 22 shows a management configuration constructed after the new parent device 105 is selected.

The child device management range is divided as shown by blocks 2101 and 2102 in FIG. 22. The parent device 101 transmits, to the management server 1402, management data on child devices in the range 2101 to which the parent device 101 belongs. The parent device 105 transmits to the management server 1402 management data on child devices in the range 2102 to which it belongs.

Network Communication in the Second Embodiment

Next, a communication sequence in the second embodiment is described.

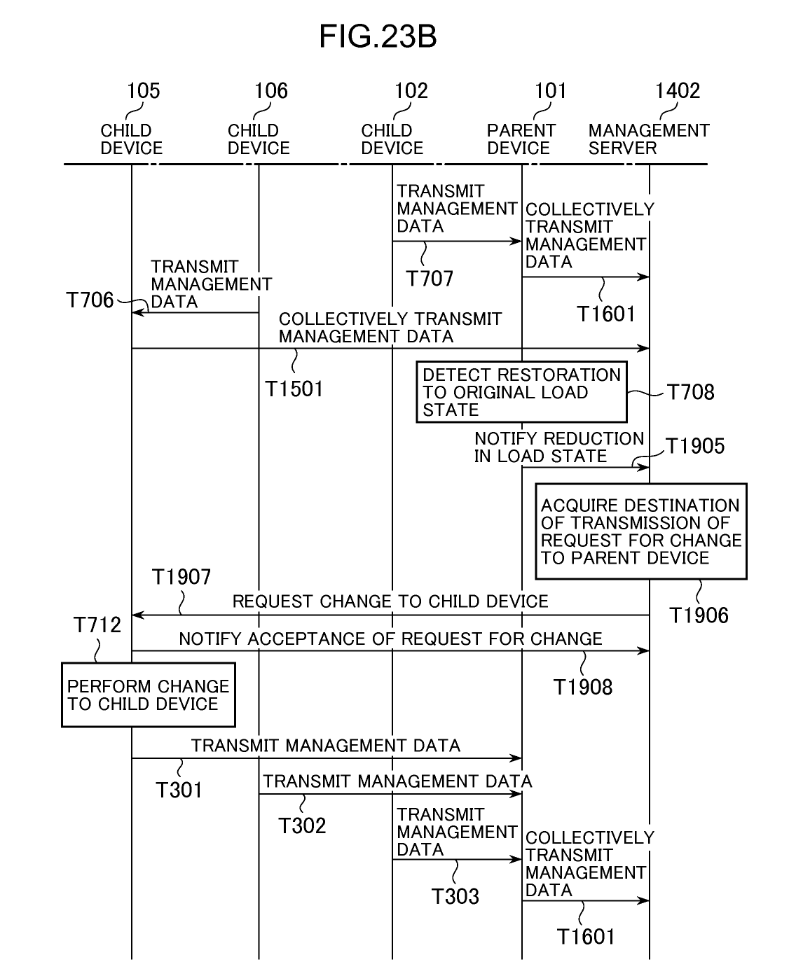

FIGS. 23A and 23B show in sequence diagram a network communication in this embodiment.

Processing denoted by T301 to T303 and T1601 in FIGS. 23A and 23B corresponds to the communications for management data acquisition described with reference to FIG. 19.

When detecting a high load state (T701), the parent device 101 notifies the load state to the management server 1402 (T1901). In response to the notification, the management server 1402 selects a candidate new parent device from child devices in the list held therein (T1902), and transmits to the selected device 105 a request for change to a parent device (T1903). When the request is accepted by the device 105, an acceptance notification is transmitted from the device 105 to the management server 1402 (T1904). Subsequent communications are carried out in the same manner as in the first embodiment.

When detecting a low load state (T708), the parent device 101 transmits a load state notification to the management server 1402 (T1905). In response to the notification, the management server 1402 finds the device 105 updated to the parent device by the management server 1402 (T1906) and transmits to the device 105 a request for change to a child device (T1907). When the request is accepted by the device 105, an acceptance notification is transmitted from the device 105 to the management server 1402 (T1908). Subsequent communications are carried out in the same manner as in the first embodiment.

Internal Process in the Parent Device in the Second Embodiment

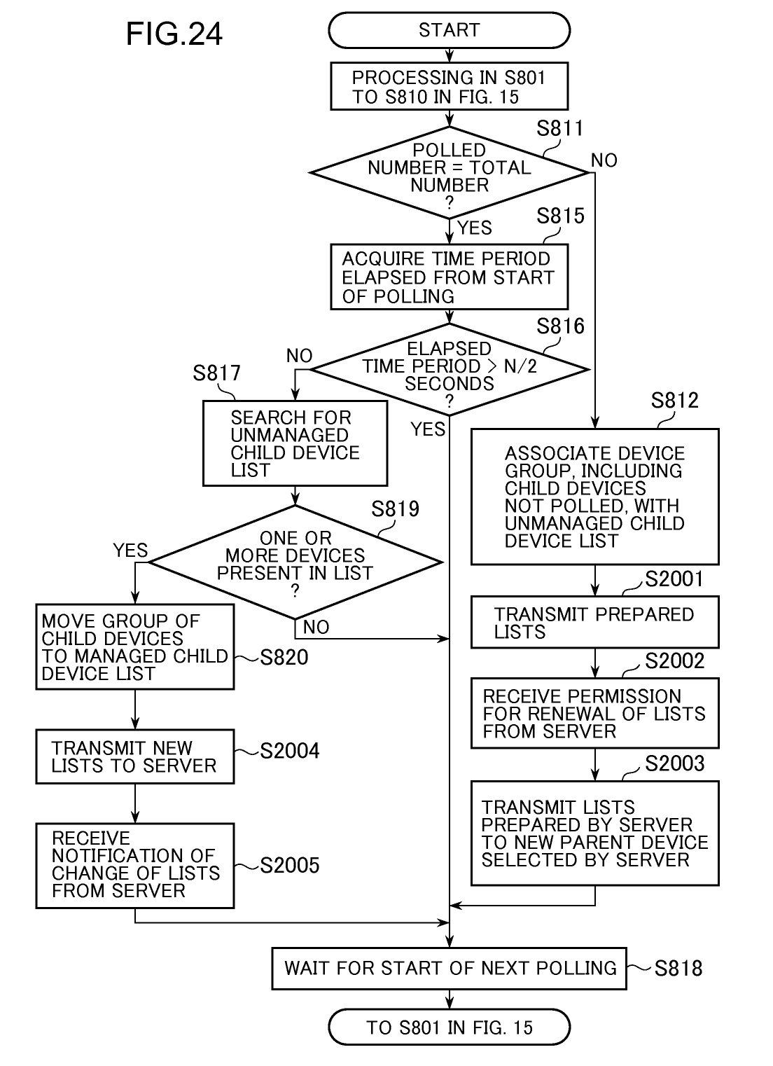

Next, an example internal process implemented by the parent device 101 for the above network communications in the second embodiment is described with reference to FIG. 24.

FIG. 24 shows in flowchart the internal process performed by the parent device 101 of the second embodiment. In FIG. 24, steps common to those of the internal process in the first embodiment shown in FIGS. 15 and 16 are denoted by like step numbers, and a description thereof is omitted.

The internal process of this embodiment is different from the first embodiment in those processing which are carried out when it is detected in S811 by a reception load detecting unit 1703 that some of the child devices in the list cannot be polled.

Specifically, in this embodiment, when a high load state is detected by the load detection unit 1703, the device load state notification unit 1704 associates the devices which cannot be polled in the current process cycle with the unmanaged child device list (S812). In S2001, the resulting new lists are transmitted to the management server 1402. When the load state notification unit 1704 receives in S2001 from the management server 1402 a response to permit the renewed lists, the new lists are transmitted in S2003 to the new parent device decided by the management server 1402, and a notification of change from the processing as a child device to the processing as a parent device is transmitted.

The internal process of this embodiment is different from the first embodiment also in the processing executed when it is determined in S816 that the parent device 101 has a sufficient polling performance. Specifically, in this embodiment, if the answer to S816 is NO, the reception load detecting unit 1703 searches for the unmanaged child device list in S817 and determines in S818 whether or not one or more child devices are present in the list. If there is no child device in the list, the process proceeds to S818 to wait for the start of the next polling. If there are one or more child devices in the list, the device load state notification unit 1704 associates, in S820, one group of child devices selected from the unmanaged child device list with the managed child device list, and transmits the resulting new managed and unmanaged child device lists to the management server 1402 in S2004. When the device load state notification unit 1704 receives a response from the management server 1402 in S2005, the process proceeds to S812 to wait the start of the next Dolling.

### Modifications

The present invention is not limited to the above described first and second embodiments, but may be modified variously. The following is a description of an example modification.

In the example modification, the second embodiment is modified to have a construction to increase the number of parent devices for load distribution in response to the increase in load detected on a per time zone basis. Specifically, information on operation states of devices is transmitted to and held in the management server 1402.

When detecting an increase in load of the parent device 101 from the operation state information, the management server 1402 modifies the managed child device list for the parent device 101 in which, e.g., the devices 102 to 104 are recorded and the unmanaged child device list for the parent device 101 in which, e.g., the devices 105 to 108 are recorded.

Specifically, the management server 1402 selects a candidate for a new parent device (for example, the device 105) from the unmanaged child device list for the parent device 101. When the new parent device 105 is decided, the management server 1402 prepares new lists for the parent device 101 and the new parent device 105. The devices 102 to 104 are recorded in the new managed child device list for the parent device 101 and the devices 105 to 108 are recorded in the new unmanaged child device list for the parent device 101. The devices 105 to 107 are recorded in the managed child device list for the new parent device 105 and nothing is recorded in the unmanaged child device list for the new parent device 105.

Next, the management server 1402 notifies the parent devices 101 and 105 of the lists concerned, together with information on a time zone detected by the management server 1402. As a result, the devices 105 to 108 constitute one group to be managed by the new parent device 105 over the time zone detected by the management server 1402.

It is to be understood that the present invention may also be accomplished by supplying a system or an apparatus with a storage medium in which a program code of software, which realizes the functions of the above described embodiments is stored and by causing a computer (or CPU or MPU) of the system or apparatus to read out and execute the program code stored in the storage medium.

In that case, the program code itself read from the storage medium realizes the functions of the above described embodiments, and therefore the program code and the storage medium in which the program code is stored constitute the present invention.

Examples of the storage medium for supplying the program code include a floppy (registered trademark) disk, a hard disk, and a magnetic-optical disk, a CD-ROM, a CD-R, a CD-RW, a DVD-ROM, a DVD-RAM, a DVD-RW, a DVD+RW, a magnetic tape, a nonvolatile memory card, and a ROM. The program code may be downloaded via a network.

Further, it is to be understood that the functions of the above described embodiments may be accomplished not only by executing the program code read out by a computer, but also by causing an OS (operating system) or the like which operates on the computer to perform a part or all of the actual operations based on instructions of the program code.

Further, it is to be understood that the functions of the above described embodiments may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-095231, filed Apr. 1, 2008, which is hereby incorporated by reference herein in its entirety.

What is claimed is:

1. A network system including a plurality of devices connected to a network, at least one of the plurality of devices being configured to operate as a management device that collects and manages data transmitted from at least one remaining device that operates as at least one managed device, the network system comprising:
a changing unit adapted to change at least one of the at least one managed device to a new management device in a case where there occurs a change in state of the management device; and
a unit adapted to change the new management device to a managed device in a case where the state of the management device is restored to its original state.

2. A device connected to a plurality of other devices via a network, comprising:
a collecting unit adapted to collect data transmitted from the plurality of other devices;
a detecting unit adapted to detect a state of the device;
a changing unit adapted to change at least one of the plurality of other devices from a managed device to a management device in a case where said detecting unit detects that load on the device is high; and
a unit adapted to change the device changed to the management device by said changing unit to the managed device in a case where said detecting unit detects that the load of the device is low.

3. The device according to claim 2, including:
a user interface having a screen on which information is displayed; and
a display control unit adapted to control display of information on managed devices managed by the device on the screen of said user interface.

4. The device according to claim 2, including:
a user interface having a screen on which information is displayed; and
a display control unit adapted to control display of information on that device which is changed to the management device by the device on the screen of said user interface.

5. The device according to claim 2, including:
a user interface having a screen on which information is displayed; and
a display control unit adapted to control display of a management configuration of the management device and managed devices on the network on the screen of said user interface.

6. A device adapted to operate as a managed device managed by a management device, comprising:
a changing unit adapted to change the device such as to operate as a new management device in response to an instruction transmitted from the management device to change the device to the new management device;
a receiving unit adapted to receive, from the management device, information indicating at least one device to be managed by the device changed to the new management device by the management device;
a collecting unit adapted to collect data from the at least one device to be managed by the new management device in accordance with the information received by said receiving unit; and
a unit adapted to change the device such as to operate as a managed device in response to an instruction transmitted from the management device to change the device to the managed device.

7. A network system including a plurality of devices connected to a network on which a server apparatus is disposed, at least one of the plurality of devices being configured to operate as a management device that collects data transmitted from at least one remaining device that operates as at least one managed device and the collected data being managed by the server apparatus, the network system comprising:
a changing unit adapted to change at least one of the at least one managed device to a new management device in accordance with an instruction transmitted from the server apparatus in a case where there occurs a change in state of the management device; and
a unit adapted to change the device changed to the new management device by said changing unit to a managed device in accordance with an instruction transmitted from the server apparatus in a case where the state of the management device is restored to its original state.

8. A device connected to a server apparatus and a plurality of other devices via a network, comprising:
a collecting unit adapted to collect data transmitted from the plurality of other devices;
a detecting unit adapted to detect a state of the device;
a changing unit adapted to change at least one of the plurality of other devices from a managed device to a management device in accordance with information transmitted from the server apparatus in a case where said detecting unit detects that load on the device is high; and
a unit adapted to change the device changed to the management device by said changing unit to the managed device in accordance with information transmitted from the server apparatus in a case where said detecting unit detects that the load of the device is low.

9. A control method of a device connected to a plurality of other devices via a network, comprising:
a collecting step of collecting data transmitted from the plurality of other devices;
a detecting step of detecting a state of the device;
a changing step of changing at least one of the plurality of other devices from a managed device to a management device in a case where it is detected in said detecting step that load on the device is high, and
a step of changing the device changed to the management device in said changing step to the managed device in a case where it is determined in said detecting step that the load of the device is low.

10. A control method of a device adapted to operate as a managed device managed by a management device, comprising:
a changing step of changing the device such as to operate as a new management device in response to an instruction transmitted from the management device to change the device to the new management device;
a receiving step of receiving, from the management device, information indicating at least one device to be managed by the device changed to the new management device in said changing step;
a collecting step of collecting data from the at least one device to be managed by the new management device in accordance with the information received in said receiving step; and
a step of changing the device such as to operate as a managed device in response to an instruction transmitted from the management device to change the device to the managed device.

11. A computer-readable storage medium storing a program for causing a computer to execute a control method of a device connected to a plurality of other devices via a network, the control method comprising:
a collecting step of collecting data transmitted from the plurality of other devices;
a detecting step of detecting a state of the device;
a changing step of changing at least one of the plurality of other devices from a managed device to a management device in a case where it is detected in said detecting step that load on the device is high; and
a step of changing the device changed to the management device in said changing step to the managed device in a case where it is determined in said detecting step that the load of the device is low.

12. A computer-readable storage medium storing a program for causing a computer to execute a control method of a device adapted to operate as a managed device managed by a management device, the control method comprising:
a changing step of changing the device such as to operate as a new management device in response to an instruction transmitted from the management device to change the device to the new management device;
a receiving step of receiving, from the management device, information indicating at least one device to be managed by the device changed to the new management device in said changing step;
a collecting step of collecting data from the at least one device to be managed by the new management device in accordance with the information received in said receiving step; and
a step of changing the device such as to operate as a managed device in response to an instruction transmitted from the management device to change the device to the managed device.
